(19) United States
(12) Patent Application Publication
(10) Pub. No.: US 2013/0260112 A1
(43) Pub. Date: Oct. 3, 2013

(54) IN-MOLD GRAIN SKIN LAMINATION FOR INTERIOR TRIM PANEL WITH DECORATIVE APPLIQUÉ

(71) Applicants: Yun Shin Lee, Shelby Township, MI (US); John W. Johnston, Royal Oak, MI (US)

(72) Inventors: Yun Shin Lee, Shelby Township, MI (US); John W. Johnston, Royal Oak, MI (US)

(73) Assignee: FORD GLOBAL TECHNOLOGIES, LLC, DEARBORN, MI (US)

(21) Appl. No.: 13/437,407

(22) Filed: Apr. 2, 2012

(51) Int. Cl. B32B 3/10; B44C 1/20

(52) U.S. Cl. 428/200; 156/219

(57) ABSTRACT

A method for forming a composite trim panel for a vehicle interior begins with a sheet-like appliqué being loaded onto a female negative-vacuum molding tool, wherein the appliqué has a Class A surface facing the female negative-vacuum molding tool and a Class B surface having a heat-activated adhesive. A skin-forming sheet is heated. The skin-forming sheet is negative-vacuum formed into a trim panel skin in the female negative-vacuum molding tool surrounding and atop of the appliqué, wherein the trim panel skin surrounding the appliqué is formed with an in-mold grain. While the trim panel skin remains pliable from the heating and remains in the female negative-vacuum molding tool, a pre-molded rigid substrate is pressed against the trim panel skin to adhere them together.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to interior trim panels of automotive interiors, and, more specifically, to skin-covered substrates having decorative appliqués.

Interior trim panels are used to finish the interior surfaces in an automotive vehicle passenger compartment, and include door panels and instrument panels, for example. A typical trim panel may include a rigid support substrate that attaches to the door or a dashboard foundation and a flexible skin covering the substrate and having a desired color. The in-mold grain molding process is a popular way of manufacturing a trim panel skin due to its ability to create a skin with good appearance, good durability, and low cost. Sheets of skin-forming material are typically vacuum formed in a female negative-vacuum molding tool to create a desirable grain or textured surface on the visible side of the skin.

Conventional manufacturing and assembly of trim panels has required many processing steps and assembly stations. For an in-mold grain laminated (IMG-L) skin, the sheet is vacuum formed, cooled, removed from the mold, and trimmed before being transported to and loaded into another device for finally attaching it to the substrate.

For styling purposes, decorative appliqués such as a plate or other partial overlays may be placed over a skin. Especially when covering an appreciable length on a door panel or an instrument panel, the associated attachment hardware for installing the appliqué may cause problems in meeting vehicle crash requirements such as side impact requirements. When it gets its support from just a few mechanical fastening points, the appliqué is required to have a proper thickness to maintain its dimensional stability. Fasteners for holding the appliqué may extend behind the skin and substrate, thereby consuming scarce packaging space and potentially interfering with the desired impact responses.

It has not been possible to attach an appliqué on the skin during the skin forming process because of shrinkage that occurs in the skin when it cools. If co-formed with the skin, the lack of shrinkage of the appliqué would lead to distortion of the skin due to its differential shrinkage.

### SUMMARY OF THE INVENTION

In one aspect of the invention, a method is provided for forming a composite trim panel for a vehicle interior. A sheet-like appliqué is loaded onto a female negative-vacuum molding tool, wherein the appliqué has a Class A surface facing the female negative-vacuum molding tool and a Class B surface having a heat-activated adhesive. A skin-forming sheet is heated. The skin-forming sheet is negative-vacuum formed into a trim panel skin in the female negative-vacuum molding tool surrounding and atop of the appliqué, wherein the trim panel skin surrounding the appliqué is formed with an in-mold grain. While the trim panel skin remains pliable from the heating and remains in the female negative-vacuum molding tool, a pre-molded rigid substrate is pressed against the trim panel skin to adhere them together.

### BRIEF DESCRIPTION OF THE DRAWINGS

FIG. 1 is an exploded view showing a conventional method for assembling a composite trim panel with a substrate, skin, and decorative appliqué.

FIG. 2 is a cross-sectional view of a conventional mechanical attachment of a decorative appliqué.

FIGS. 3 and 4 illustrate a conventional in-mold grain (IMG) method for making a skin for a trim panel.

FIG. 5 shows an improved mold and manufacturing process according to one embodiment of the present invention.

FIG. 6 is a flowchart showing an embodiment of the invention.

FIG. 7 is a cross section showing the crushing of a TPO foam skin layer behind an appliqué.

FIG. 8 is a cross section showing the skin protruding over the edges of an appliqué to provide mechanical retention.

### DETAILED DESCRIPTION OF PREFERRED EMBODIMENTS

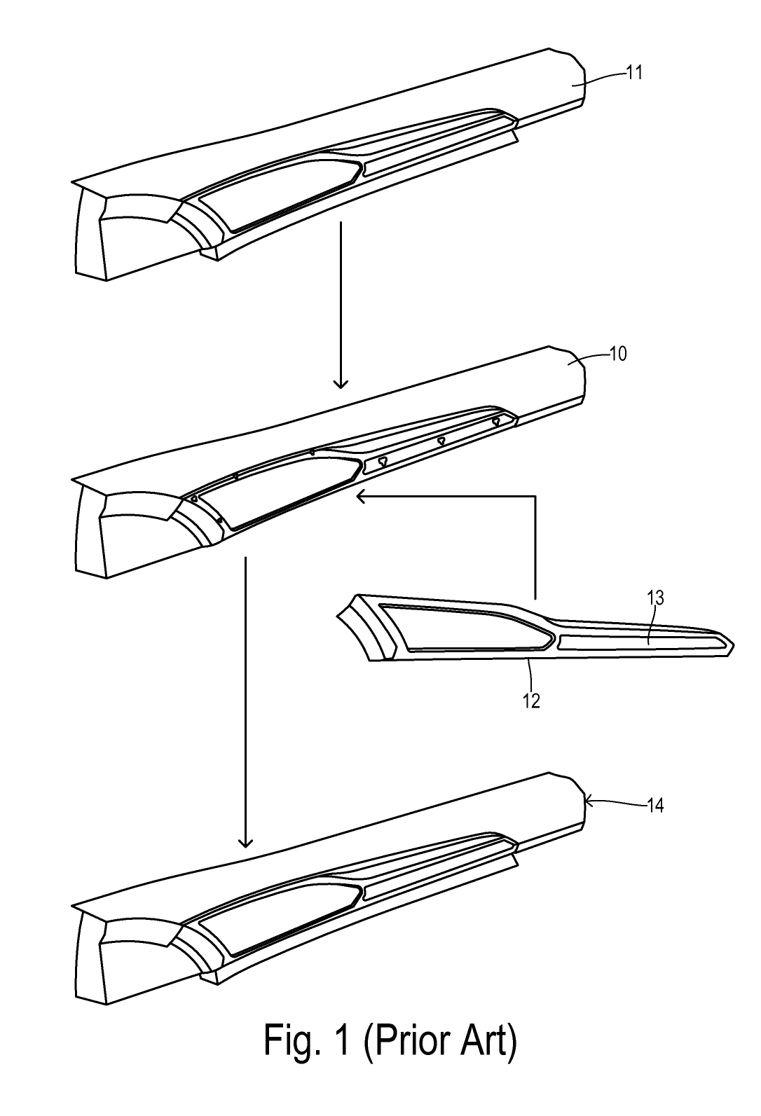

As shown in FIG. 1, a conventional door trim panel assembly may include an injection-molded substrate 10 that receives a prefabricated skin 11 followed by a decorative appliqué 12. Appliqué 12 may comprise a composite structure having an insert 13 on one surface thereof, or it may simply consist of a single layer. A finished assembly 14 may comprise an arm rest portion of a door trim panel and includes an opening 18 to accommodate armrest switches such as window and lock controls. Each of the subcomponents 10, 11, and 12 are individually made and then assembled together as a unit.

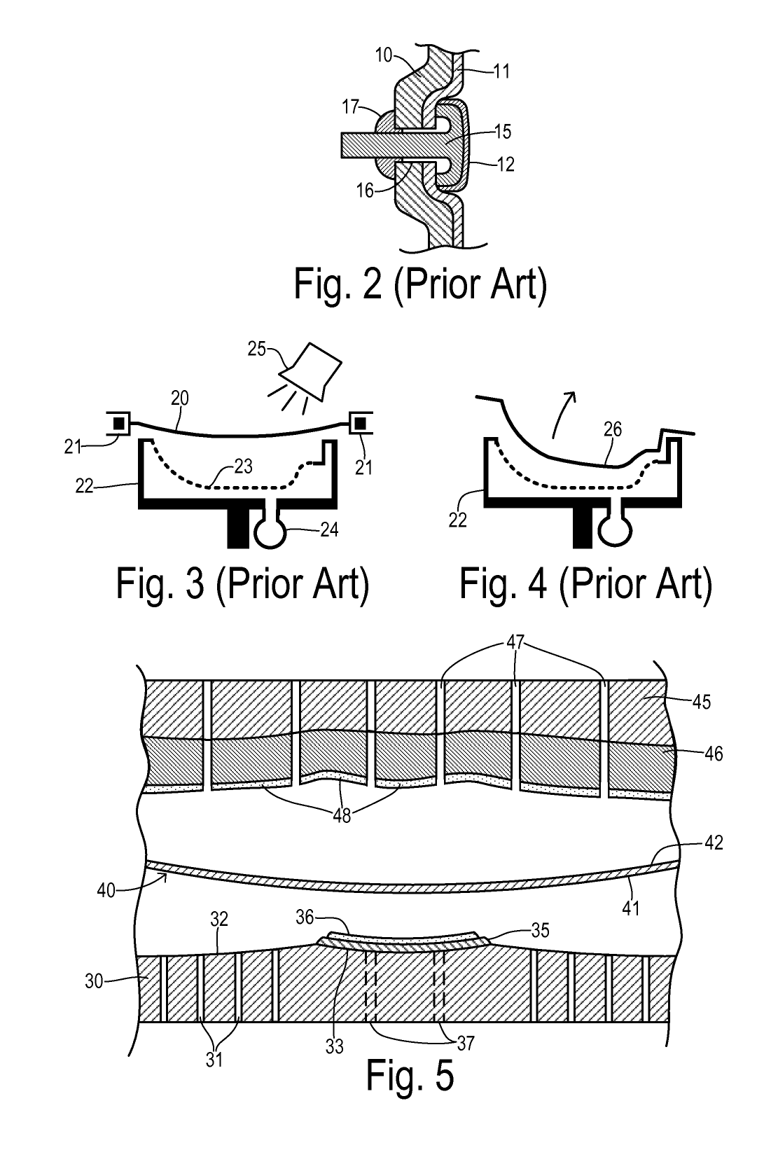

FIG. 2 shows a conventional manner for retaining the subcomponents in an assembly. Substrate 10 is molded with a shape having a fastening hole 16. Appliqué 12 is formed having mounting boss 15 which passes through hole 16 and a corresponding hole punched in skin 11. Boss 15 then may be attached with a nut or may be heat-staked onto the Class B side of substrate 10.

FIGS. 3 and 4 shows a conventional IMG process for manufacturing a skin. A skin-forming sheet 20 is suspended by a fixture 21 over a female negative-vacuum molding tool 22. A mold surface 23 includes a plurality of apertures 23 each in fluid communication with a vacuum source 24. Sheet 20 is heated by a heat source 25 so that it becomes pliable. In response to sheet 20 being lowered over the mold surface in the presence of a vacuum from vacuum source 24, sheet 20 is vacuum-formed into a skin 26. Skin 26 may be removed and trimmed after cooling. Tooling surface 23 includes a conventional textured surface for imparting a grain onto the Class A finished side of skin 26 as known in the art. Skin-forming sheet 20 may be comprised of a thermoplastic polyolefin (TPO) or other conventional materials, including other forms of polypropylene or polyethylene.

As shown in FIG. 5, the present invention achieves efficient processing while avoiding prior art problems associated with differential shrinkage and the need to accommodate mechanical fasteners. In particular, a sheet-like appliqué may be attached to the trim panel skin during negative-vacuum forming followed by immediate attachment of the skin to the substrate before shrinkage of the skin can occur. The appliqué is preferably an injection-molded rigid part, but can alternatively be flexible. It can be formed of any material that can withstand the heat applied to the skin material. The appliqué can also comprise various single or multi-layer films that may be coated or colored. The sheet-like appliqué may be contoured or curved, but preferably lacks any bosses or other protrusions.

A female-negative vacuum molding tool 30 includes vacuum passages 31 coupled to a grained mold surface 32. A cavity or other dedicated section 33 of molding tool 30 is adapted to receive a sheet-like appliqué 35. A heat-activated adhesive 36 is applied to the Class B (rear-facing) side of appliqué 35 which will allow appliqué 35 to adhere to the skin that is being molded from a skin-forming sheet 40. Vacuum passages 37 may optionally be provided to assist in retaining appliqué 35 in the desired location on cavity 33, if necessary. Gravity alone will sometimes be sufficient to keep appliqué 35 in the desired position. Raised tabs or ridges in mold surface 32 can also be employed to retain appliqué 35 in the desired position.

Skin-forming sheet 40 may preferably be comprised of TPO. Sheet 40 can be a single layer or can be laminated as known in the art. Sheet 40 preferably includes a layer of polymeric foam (e.g., a bi-laminate with soft TPO over an expanded polyolefin foam). Class A surface 41 of sheet 40 faces molding tool 30 and a Class B surface 42 faces a male vacuum-molding plug 45 which carries substrate 46. Vacuum passages 47 through molding plug 45 and substrate 46 couple a vacuum source (not shown) to the formed skin when bonding the skin to the substrate. Surfaces of substrate 46 are coated with a heat-activated adhesive 48 that is used to bond substrate 46 together with skin-forming sheet 40 after it is shaped into the skin.

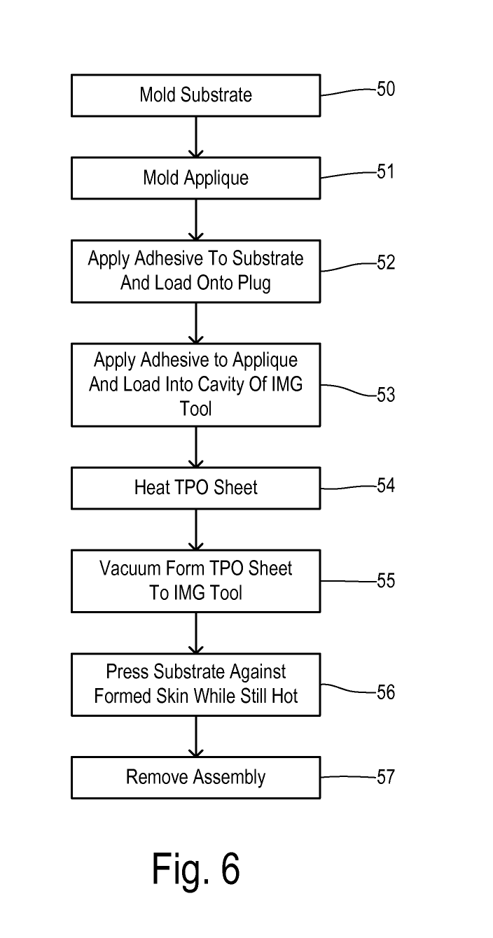

One embodiment of a method of the invention will be described in connection with FIG. 6. In step 50, the substrate is molded in a conventional manner (e.g., by injection molding a plastic such as ABS with the appropriate rigidity and having features for attaching the trim panel to a door or dashboard). In step 51, the appliqué is molded (e.g., by the injection molding of an appropriate plastic material). Alternatively, the appliqué may be formed from a die-cut film or other prefabricated materials. The appliqué may also be formed as a composite article using conventional technology, such as an injection-molded carrier with optional films, inserts, and coatings.

In step 52, a heat-activated adhesive is applied to the Class A side of the substrate and it is loaded onto the molding tool plug (i.e., a male molding tool). A heat-activated adhesive is also applied to the Class B side of the appliqué and it is loaded into the cavity of the female negative-vacuum molding IMG tool in step 53. A TPO sheet is heated in step 54 in close proximity with the IMG tool. The TPO sheet is vacuum formed into the desired skin in step 55. The vacuum between the female molding tool and the TPO sheet draws the TPO sheet surrounding and atop the appliqué. The heat of the TPO sheet activates the adhesive on the appliqué thereby bonding the appliqué to the formed skin. The vacuum to the female molding tool is deactivated.

While the skin remains pliable and hot, and while it remains in the female negative-vacuum IMG molding tool, the plug and substrate are pressed against the formed skin in step 56. Heat from the skin activates the adhesive carried by the substrate thereby bonding them together so that the skin is prevented from shrinking when it cools. A vacuum is activated for the male molding tool so that the skin is drawn against the substrate and the adhesive. To ensure activation of the adhesive, the substrate should be pressed against the trim panel skin promptly after the negative-vacuum forming of the skin-forming sheet to ensure that sufficient heat remains.

The assembly is removed in step 57 resulting in a composite trim panel formed with reduced process steps, lower costs, less packaging space requirements, and an ability to use thinner appliqués since dimensional stability of the appliqué is obtained by fully bonding the entire Class B surface of the appliqué to the skin and substrate.

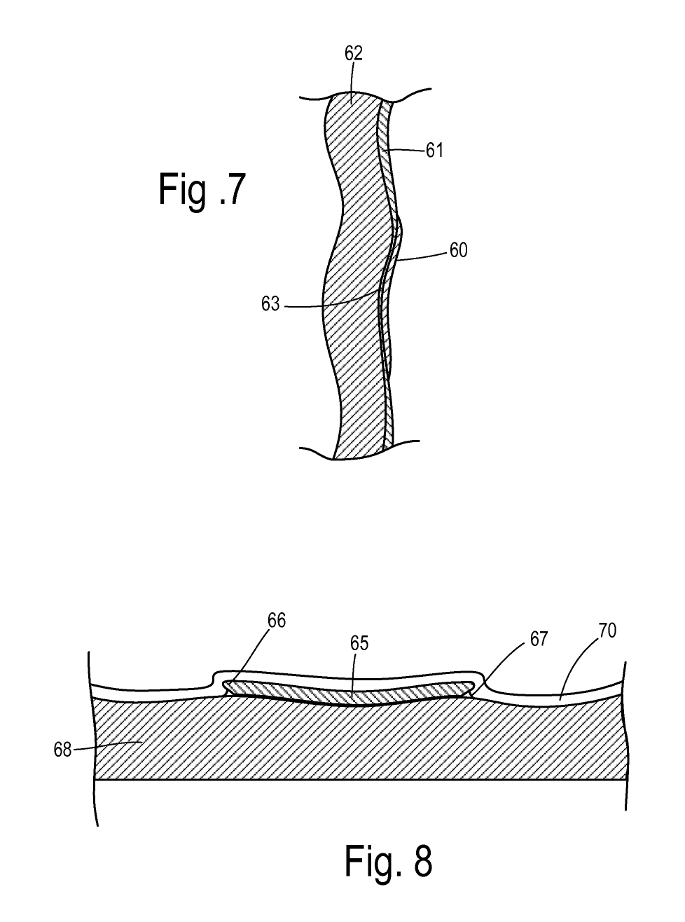

When the skin includes a foam layer, it has been discovered that the appliqué may exhibit a springy feel from the Class A side of a finished product. This may be undesirable in some product applications. In an embodiment shown in FIG. 7, such a springy feel is reduced or eliminated using compression of the skin between the substrate and appliqué during bonding. Thus, a trim panel of the invention includes an appliqué 60 bonded to a skin 61 having a backing layer of polymeric foam. Skin 61 is bonded to a substrate 62. In a region 63 of skin 61, skin 61 has been crushed in order to collapse the cellular foam structure, thereby reducing the thickness and springiness in region 63. Compression is achieved by appropriately controlling the distance between substrate 62 (acting as a plug) and the female negative-vacuum molding tool during the manufacturing process.

In addition to the adhesive bonding of the appliqué with the skin, a mechanical bonding between the appliqué and skin can be employed to further strengthen retention of the appliqué. As shown in FIG. 8, an appliqué 65 may be provided with a perimeter flange 66 extending along one or more edges. Flange 66 is spaced away from the surface of female molding tool 68 so that a space 67 is created between flange 66 and tool 68. When a skin 70 is negative-vacuum formed against tool 68, it is drawn into space 67 to overcut flange 66. By covering flange 66, skin 70 improves the retention of appliqué 65 onto the assembly.

What is claimed is:

1. A method for forming a composite trim panel for a vehicle interior, comprising the steps of:
loading a sheet-like appliqué onto a female negative-vacuum molding tool, wherein the appliqué has a Class A surface facing the female negative-vacuum molding tool and a Class B surface having a heat-activated adhesive;
heating a skin-forming sheet;
negative-vacuum forming the skin-forming sheet into a trim panel skin in the female negative-vacuum molding tool surrounding and atop of the appliqué, wherein the trim panel skin surrounding the appliqué is formed with an in-mold grain; and
while the trim panel skin remains pliable from the heating and remains in the female negative-vacuum molding tool, pressing a pre-molded rigid substrate against the trim panel skin to adhere them together.

2. The method of claim 1 wherein the substrate carries a second heat-activated adhesive which is activated by heat from the trim panel skin.

3. The method of claim 1 wherein the sheet-like appliqué includes a perimeter flange that creates a space between the sheet-like appliqué and the female negative-vacuum molding tool, and wherein the skin-forming sheet enters the space during the negative-vacuum forming step.

4. The method of claim 1 wherein the appliqué is comprised of an injection-molded plastic component.

5. The method of claim 1 wherein the appliqué is comprised of a die-cut film.

6. The method of claim 1 wherein the appliqué is a composite article.

7. The method of claim 1 wherein the female negative-vacuum molding tool includes a cavity for receiving the appliqué.

8. The method of claim 1 wherein the trim panel skin is unperforated by the appliqué.

9. The method of claim 1 wherein the skin-forming sheet is comprised of thermoplastic polyolefin.

10. The method of claim 1 wherein the skin-forming sheet includes a polymeric foam.

11. The method of claim 10 wherein the step of pressing the pre-molded rigid substrate against the trim panel skin crushes the polymeric foam.

12. The method of claim 1 wherein the substrate is comprised of injection-molded plastic.

13. The method of claim 12 wherein the plastic is comprised of ABS.

14. The method of claim 1 wherein the substrate is pressed into the female negative-vacuum molding tool by a plug, wherein the plug couples a vacuum through the substrate to the trim panel skin.

15. A composite trim panel for a vehicle interior, comprising:
a rigid substrate for attaching to the vehicle;
a trim panel skin adhered to the substrate; and
an appliqué adhered to the trim panel skin;
wherein the trim panel skin has a Class A surface having an in-mold grain formed continuously with shaping the trim panel skin to match the rigid substrate, wherein the appliqué is bonded to the Class A surface of the trim panel skin by a first heat-activated adhesive simultaneously with shaping the trim panel skin, wherein the rigid substrate is bonded to the trim panel skin by a second heat-activated adhesive that is activated by heat from the shaping of the trim panel skin.

16. The composite trim composite trim panel of claim 15 wherein the appliqué is comprised of an injection-molded plastic component.

17. The composite trim composite trim panel of claim 15 wherein the appliqué is a composite article.

18. The composite trim composite trim panel of claim 15 wherein the trim panel skin is comprised of thermoplastic polyolefin, wherein the appliqué includes a perimeter flange, and wherein the trim panel skin overcuts the perimeter flange as a result of shaping the trim panel skin.

19. The composite trim composite trim panel of claim 15 wherein the trim panel skin includes a polymeric foam, and wherein the polymeric foam bonded to the appliqué is crushed.

20. The composite trim composite trim panel of claim 15 wherein the substrate is comprised of injection-molded plastic.
